(19) United States
(12) Patent Application Publication
(10) Pub. No.: US 2003/0051587 A1
(43) Pub. Date: Mar. 20, 2003

(54) Detaching device

(76) Inventors: Roland Zeuschner, Argenbuhl (DE); Andreas Erd, Ellhofen (DE); Herbert Adler, Lindenberg (DE); Wilhelm Baur, Gestratz (DE)

Correspondence Address: LOWE HAUPTMAN GILMAN & BERNER, LLP, Suite 310, 1700 Diagonal Road, Alexandria, VA, 22314, US

(21) Appl. No.: 10/233,776

(22) Filed: Sep. 4, 2002

(30) Foreign Application Priority Data
Sep. 5, 2001 (DE) 101 43 453.7

(51) Int. Cl. B26D 7/06

(52) U.S. Cl. 83/27; 83/102

(57) ABSTRACT

Procedure for automatic removal of a piece of cheese 10, which is detached from a block of cheese 3 by a cut but is still stuck to the block, and a conveying device 1 feeds the block of cheese in a continuous motion to a detaching device 4 and the detaching device 4 has a removal device, which turns the piece of cheese 10 found on the front side of the block of cheese sideways, removes it in a separating motion and then feeds it into a discharge device 15.

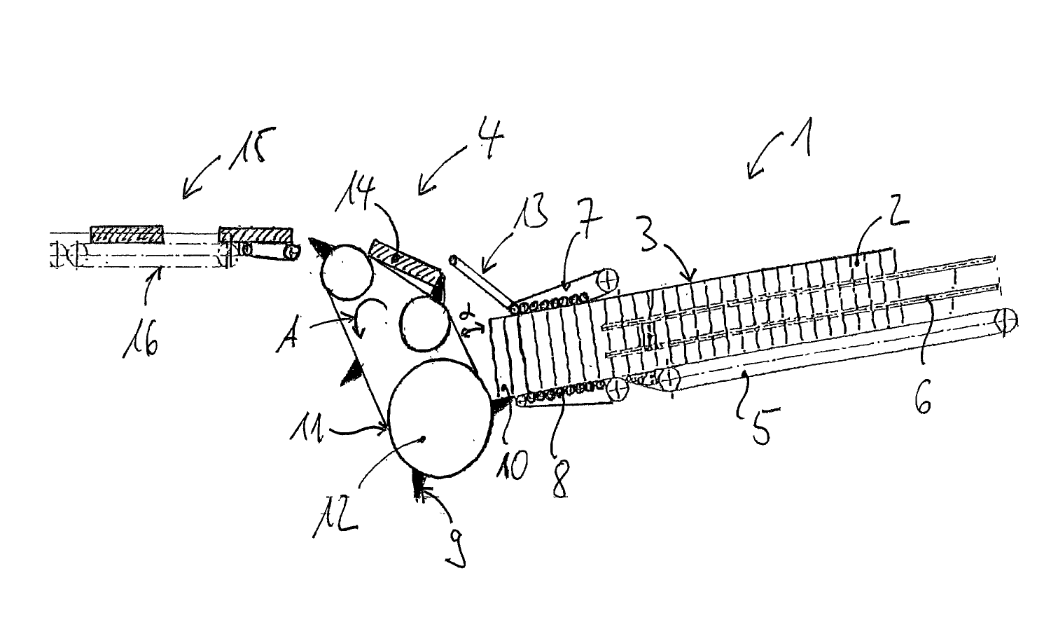

The present invention relates to a procedure for automatic detachment of one or more pieces of cheese, which is detached from a cheese block by a cut but is still stuck to the block. At the same time, the invention relates to a device suitable for carrying out this procedure.

The following problems occur when producing pieces of divided cheese and/or bars of cheese. The pieces are cut off from a large block of hard cheese or solid processed cheese. Consequently, the block is cut into individual slices of specified thickness and subsequently the stack of individual slices is cut into pieces of cheese, or bars of cheese, by cutting that occurs in an axial direction. When cutting the stack of slices—in which the individual slices stick to each other due to the force of adhesion—a knife is used, which can also be made from tense wires, and the slices press against each other so much that they stick together even more strongly. Pieces of cheese cut in this way must be individually peeled from the stack afterwards. Until now this process in producing such pieces of cheese has been done by hand. This step requires an additional worker and is thus comparably expensive; particular attention must also be given to see that this worker carries out the manual detachment of the pieces with the necessary hygiene.

The task of the invention is therefore to create a procedure for automatic detachment of these kinds of stacks of cheese that is reliable, easy to use, economical, and that allows for the flawless hygienic implementation of this step in production. Thus, the task is also to create a device for separating such stacks.

This task is solved using the procedure according to claim 1 and the device according to claim 4.

The basic idea of the invention is found in that a precut block of cheese can be fed into a detaching device by means of a feeding device that is in constant motion, and that can also occur in defined steps. The detaching device is a means of separation whereby the pieces on the front side of the block of cheese are hit sideways, removed in a separating motion, and respectively peeled from the block. After detachment it is fed into a discharge device, which in the simplest cases only need be a collecting container. With this procedure, which makes use of the lateral motion, and in particular the constant peeling, the process of “detachment” can easily be done automatically. With the device used in the procedure, the means of removal is designed as a remover which is set to return cyclically laterally on the most front part of the face of the block of cheese and removes these from the stack. Moreover, it is advantageous that the invention allows for a particularly “clean” detachment and thus contributes greatly to hygiene. As a result, cleaning can be done with simple foam and rinsing with hot water. High pressure cleaning is unnecessary.

The invented device enables an “in-line” flow of production, i.e. the intake and delivery of the product occurs in the flow direction of equipment leading into and out of the device. The invention allows for a particularly simple design of the equipment, which is freely accessible from the operating side. The cut block of cheese can be placed upright or standing on its side. The bands and belts can be loosened quickly and easily, and can thus be comfortably cleaned. Furthermore, the equipment is easy to operate and can be ergonomically designed.

The special design shape of the invention basically relates to a detaching motion with which the pieces of cheese can be peeled off quickly, “without pushing them” and thus the product is detached from the stack without any damage. Generally, it is advantageous if the separating motion is a kind of shearing motion for feeding the block of cheese in a basically perpendicular motion. Through this motion, individual pieces of cheese can be pushed down from the block of cheese. Depending on how sticky the cheese is, and how strong the individual pieces bake together, this perpendicular pushing motion must be combined with movement in an axial direction in relation to the block of cheese so that the angle towards the front side is sloped causing a tipping or peeling type of cutting of the piece of cheese.

It is particularly easy to change the invention if the removal device that has been designed is attached via a roller to a continuous belt. With the supply by means of the roller, each direction of motion can be adjusted and the device can be adapted in this way for different kinds of cheese under different conditions. In this way, the belt with the means of removal forms a device, which can be called an isolating belt. Here, it is particularly beneficial if the continuous belt has the same distance divided many times along the circumference of the removal device, which is similar to a “Pater Noster” procession in that it removes the pieces of cheese from the front side of the block of cheese and transports them up to the feeding device. It is beneficial to set the continuous belt in such a way that the removal device lies underneath the piece of cheese and removes the cheese from the block of cheese in a feeding motion that is sloping upwards. The slicing of the cheese can be particularly well controlled with this upward motion.

From time to time, the slices on the front side of the block of cheese are pre-cut into several bars of cheese that arranged parallel. It is particularly in this case that the individual slices stubbornly stick together because the cuts along the axis of the block have occurred and the knife or cutting wires have compressed the stack. However, in order to be able to detach several bars individually, it is advantageous if the continuous belt has several removal components side by side along the width of the belt. Here it is also possible to design the continuous belt with several individual belts lying next to each other, which according to the structure of their gap increase a little bit in relation to each other so that the individual bars are detached from each other. The elements are brought together during the course of the continuous motion.

In order to feed the individual pieces or bars easily and in so doing be able to put them on the isolating belt, it is advantageous to equip the removal device with a guide belt that is set directly above the block of cheese. When the removal device removes a piece of cheese, it pushes against the side surface of the above guide belt and is put by the belt onto an isolating belt.

A FIGURE of the invention's design is described in more detail in the following block schematic diagram:

The FIGURE shows a detaching device (“Denester”) for a stack of pre-cut pieces of cheese. In contrast to the usual slices used for sandwiches, the pieces of cheese have a greater thickness of more than a centimeter. As explained, this device for detaching individual pieces of cheese, which can pre-cut several bars, has a feeding device 1, over which a pre-cut block of cheese 3 that has been cut into slices 2 can be fed through a detaching device 4. The feeding device 1 also has a transfer area in which the transfer belts 7 are set above and below the block of cheese 3 and exercise increased feeding pressure on the block by means of a number of small rollers 8.

The detaching device 4 is equipped with a removal device, which in this case is realized by several continuous belts 11 via the length at the same distance of the distributed removal device 9, which—like a “Pater Noster”—respective to the front side of the block of cheese, takes away the pieces of cheese 10 and releases them from the block through more motion. Because the separation motion is sloped for the angle α against the front side of the cheese 3, this causes hard cheese to tip, or with somewhat softer cheese, a peeling removal of the piece of cheese 10. The continuous belt 11 is fed via three rollers 12, with which the angle α can be set. With feeding of the belt and/or several belts set up next to each other, the removal device 9 is laterally positioned for cyclical recurrence (arrow A) respective to the pieces of cheese 10 forming on the front side of the block of cheese and it removes these pieces from the block of cheese. The detaching device 4 also has a guide belt 13, which is set on the top part of the block of cheese 3. A piece of cheese 10 that is removed by the removal device 9 pushes against its upper side surface on the guide belt 13 and is placed by this on the belt 11.

The detaching device 4 transfers one or more detached pieces of cheese 14 to a discharge device 15, which is set up on belt 16 for further processing, in particular to take it to a scale to be weighed. The conveying device 1, the detaching device 4 and the discharge device 15 are all “in-line”.

1. Procedure for automatic parting of a piece of cheese (10), which is detached from a block of cheese (3) by a cut but is still stuck to the block, and a conveying device (1) feeds the block of cheese in a continuous motion to a detaching device (4) and the detaching device (4) has a removal device which turns the piece of cheese (10) found on the front side of the block of cheese sideways, detaches it in a separating motion and then feeds it into a discharge device (15).

2. Procedure according to claim 1,
wherein the separation motion is a cutting motion, which basically has a motion component vertical to the movement of the block of cheese, and with which the piece of cheese (10) is pushed down from the block of cheese (3).

3. Procedure according to claim 1,
wherein the separation motion has a motion component, which is sloped to the angle (α) against the front surface and causes a tipping or peeling of the piece of cheese (10).

4. Device for detaching a piece of cheese from a block of cheese, in particular according to the procedures of the aforementioned claims, that has a conveying device over which a pre-cut block of cheese can be conveyed to a means of removal equipped with a removal device,
wherein the detaching device (4) has a designed removal device, which is set for cyclical lateral recurrence respective to the front surface of the piece of cheese (10) forming from the block of cheese, and it removes the piece from the block of cheese (3), in particular, it peels it away.

5. Device according to claim 4,
wherein the removal device (9) is attached to a continuous belt (11) via rollers (12) and thus forms a separation belt.

6. Device according to claim 5,
wherein the continuous belt (11) has a number of divided removal device (9) along the circumference at the same distance, which—like a “Pater Noster”—respective to the front side of the block of cheese takes away the pieces of cheese (10) and transports them to a dispatching device (15).

7. Device according to claims 4 to 6,
wherein the continuous belt (11) is set up in such a way that a removal device (9) is positioned underneath the pieces of cheese (10) and removes the pieces from the block of cheese (3) in a diagonally upward motion.

8. Device according to claims 4 to 7,
wherein the continuous belt (11) has several close removal devices (9) along its bandwidth, which removes individual bars or pieces of cheese after a piece of cheese has been pre-cut into several bars.

9. Device according to claims 4 to 8,
wherein the removal device (4) has a guide belt (13) set up above the block of cheese (3) whereby a piece of cheese (1) removed by the removal device (9), pushes against the guide belt (13) with the top of its side and is placed by the guide belt on the isolating belt (11).
